(19) United States
(12) Patent Application Publication
(10) Pub. No.: US 2018/0273735 A1
(43) Pub. Date: Sep. 27, 2018

(54) RUBBER COMPOSITION, RUBBER COMPOSITE, AND RUBBER CRAWLER

(71) Applicant: BRIDGESTONE CORPORATION, Tokyo (JP)

(72) Inventors: Isao HAGIWARA, Yokohama-shi (JP); Shuyo AKAMA, Saitama-shi (JP)

(73) Assignee: BRIDGESTONE CORPORATION, Tokyo (JP)

(21) Appl. No.: 15/762,142

(22) PCT Filed: Aug. 23, 2016
(86) PCT No.: PCT/JP2016/003839

§ 371 Date: Mar. 22, 2018

(30) Foreign Application Priority Data
Oct. 7, 2015 (JP) 2015-199672

(51) Int. Cl. C08L 9/06; B32B 25/04; C08L 7/00; B62D 55/24

(52) U.S. Cl. CPC C08L 9/06; B32B 25/042; C08L 2205/025; B62D 55/244; C08L 2205/03; C08L 7/00

(57) ABSTRACT

Provided is a rubber composition capable of providing rubber parts improved in adhesiveness, a rubber composite improved in adhesion force at an adhesion site of rubber parts, and a rubber crawler having improved adhesion force at an adhesion site of the rubber parts. The disclosed rubber composition contains at least a polymer component: in which the polymer component contains a styrene-butadiene rubber-containing component including either a styrene-butadiene rubber alone or a mixture of a styrene-butadiene rubber and a butadiene rubber; a styrene content in the styrene-butadiene rubber-containing component is less than 20 mass %; and the styrene-butadiene rubber is oil-extended styrene-butadiene rubber. Further, the polymer component of the disclosed rubber composition contains less than 50 parts by mass of a styrene-butadiene rubber-containing component with respect to 100 parts by mass of the polymer component, and a styrene content in the styrene-butadiene rubber-containing component is less than 20 mass %.

### TECHNICAL FIELD

The present disclosure relates to a rubber composition, a rubber composite, and a rubber crawler.

### BACKGROUND

Rubbers forming a rubber crawler are generally compounded with rubbers such as natural rubber (NR) and styrene-butadiene rubber (SBR), in order to improve mechanical properties. It has been proposed blending a diene-based polymer and a reinforcing agent into styrene-butadiene rubber as a main component, to thereby improve durability and anti-cut resistance of the rubber crawler (see PTL 1, for example).

Meanwhile, rubber crawlers generally have a site where a rubber part and another rubber part are directly adhered together. It has been found that such site may suffer peeling on an adhered surface between the rubber parts when the rubber crawler is used for a long term or under heavy load condition. Therefore, a newly-found object for the rubber crawler is to improve anti-peeling property thereof.

### CITATION LIST

### Patent Literature

PTL 1: JPH08208890A

### SUMMARY

### Technical Problem

It could be helpful to provide a rubber composition capable of providing rubber parts improved in adhesiveness, a rubber composite improved in adhesion force at an adhesion site between the rubber parts, and a rubber crawler improved in adhesion force at an adhesion site of the rubber parts.

### Solution to Problem

The disclosed rubber composition contains at least a polymer component, in which: the polymer component contains a styrene-butadiene rubber-containing component which includes either a styrene-butadiene rubber alone or a mixture of a styrene-butadiene rubber and a butadiene rubber; a styrene content in the styrene-butadiene rubber-containing component is less than 20 mass %; and the styrene-butadiene rubber is oil-extended styrene-butadiene rubber.

The disclosed rubber composition contains at least a polymer component, in which: the polymer component contains less than 50 parts by mass of a styrene-butadiene rubber-containing component, which includes either a styrene-butadiene rubber alone or a mixture of a styrene-butadiene rubber and a butadiene rubber, with respect to 100 parts by mass of the polymer component; and a styrene content in the styrene-butadiene rubber-containing component is less than 20 mass %.

### Advantageous Effect

We thus can provide: a rubber composition capable of providing rubber parts improved in adhesiveness; a rubber composite improved in adhesion force at an adhesion site between the rubber parts; and a rubber crawler improved in adhesion force at an adhesion site between the rubber parts.

### BRIEF DESCRIPTION OF THE DRAWINGS

In the accompanying drawings:

FIG. 1 is a schematic perspective view illustrating an example of the disclosed rubber crawler; and

FIG. 2 is a schematic sectional view taken along the line A-A of FIG. 1.

### DETAILED DESCRIPTION

Hereinafter, embodiments of the present disclosure will be illustrated.

The term “polymer component” herein refers to a component including a polymer, the component containing one kind or two or more kinds polymers.

The term “styrene-butadiene rubber-containing component” herein refers to either a styrene-butadiene rubber alone or a mixture of a styrene-butadiene rubber and a butadiene rubber.

The term “styrene content” herein refers to mass % of a structural part represented by the following formula (II), with respect to 100 mass % in total of a structural part represented by the following formula (I) and the structural part represented by the following formula (II) in the styrene-butadiene rubber-containing component. The structural part represented by the following formula (I) is included in styrene-butadiene rubber and butadiene rubber, and the structural part represented by the following formula (II) is included in styrene-butadiene rubber.

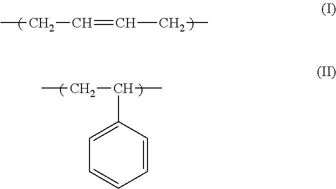

For example, with the styrene-butadiene rubber-containing component being styrene-butadiene rubber alone, the styrene content herein becomes 10 mass % with respect to the mass of styrene-butadiene rubber when 10 mass % of the structural part represented by the formula (II) is contained in the styrene-butadiene rubber to be used. Further, with the styrene-butadiene rubber-containing component being a mixture of styrene-butadiene rubber and butadiene rubber, when 80 parts by mass of styrene-butadiene rubber and 20 parts by mass of butadiene rubber are included and the mass % of the structural part represented by the formula (II) in styrene-butadiene rubber to be used is 20 mass % with respect to the mass of styrene-butadiene rubber, the styrene content herein becomes 16 mass %.

The term “oil-extended styrene-butadiene rubber” herein refers to styrene-butadiene rubber containing, in addition to styrene-butadiene rubber, extended oil such as a petroleum fraction having a high boiling point.

As disclosed herein, with the styrene-butadiene rubber being oil-extended styrene-butadiene rubber, the styrene-butadiene rubber (oil-extended styrene-butadiene rubber) content and the styrene content each represent a content excluding extended oil.

The term “styrene-butadiene-based rubber composition” herein refers to a rubber composition containing 50 mass % or more of styrene-butadiene rubber.

It has been reported that styrene-butadiene rubber having a high styrene content may be compounded into a rubber crawler, to thereby provide excellent anti-cut resistance (see PTL 1, for example). Through our extensive research on rubber compositions to be used for a rubber crawler, we have found that the use of styrene-butadiene rubber improves anti-cut resistance of rubber parts, but fails to improve adhesion force at an adhesion site where a rubber part adheres to another rubber part. Further, another problem we have found is that a rubber part mainly including styrene-butadiene rubber has low adhesion force between rubber parts, which readily leads to interfacial peeling.

Through our further extensive research, we have surprisingly found that a rubber part, in which a polymer has a low styrene content, styrene-butadiene rubber contained in a polymer component is oil-extended styrene-butadiene rubber, and the content of a styrene-butadiene rubber-containing component is less than 50 parts by mass with respect to 100 parts by mass of the polymer component, has improved adhesion force at an adhesion site between rubber parts, and particularly improved adhesion force at an adhesion site between rubber parts mainly consisting of styrene-butadiene rubber. The mechanism of how the adhesion force is improved at an adhesion site between rubber parts has not yet been clarified; however, it can be considered as ascribable to improvement in compatibility of an adhesion site between rubber parts during vulcanization molding.

(Rubber Composition)

The disclosed rubber composition contains at least a polymer component, and further contains other components as required. The disclosed rubber composition is capable of providing rubber parts having improved adhesiveness.

A method of producing a rubber composition is not particularly limited and may be arbitrarily selected according to the purpose. All raw materials of components may be compounded at once and kneaded, or each component may be compounded and kneaded separately in two or three steps.

A kneader to be used for the kneading is not particularly limited and may be arbitrarily selected according to the purpose. Examples of the kneader may include a roller, an internal mixer, and a Banbury rotor.

<Polymer Component>

The polymer component refers to a component including a polymer. The polymer component contains at least a styrene-butadiene rubber-containing component and other polymers as required.

<<Styrene-Butadiene Rubber-Containing Component>>

The styrene-butadiene rubber-containing component refers to either a styrene-butadiene rubber alone or a mixture of a styrene-butadiene rubber and a butadiene rubber.

—Styrene-Butadiene Rubber (SBR)—

Styrene-butadiene rubber (SBR) is a copolymer of a styrene monomer and a butadiene monomer. Examples of styrene-butadiene rubber may include those prepared through different methods such as: emulsion polymerized SBR (E-SBR) prepared through emulsion polymerization; and solution polymerized SBR (S-SBR) prepared through solution polymerization. One kind thereof may be used alone, or two or more kinds thereof may be used in combination. Oil-extended styrene-butadiene rubber may be used as styrene-butadiene rubber.

In particular, the use of the styrene-butadiene rubber-containing component including styrene-butadiene rubber alone provides a rubber part further improved in adhesiveness while maintaining breaking characteristics.

——Oil-Extended Styrene-Butadiene Rubber (Oil-Extended SBR)——

The oil-extended styrene-butadiene rubber refers to styrene-butadiene rubber containing, in addition to styrene-butadiene rubber, extended oil such as a petroleum fraction having a high boiling point. Oil-extended styrene-butadiene rubber contains 10 to 60 parts by mass of extended oil with respect to 100 parts by mass of styrene-butadiene rubber, for example. From a viewpoint of providing high hysteresis loss characteristics or affinity with rubber, the extended oil is aromatic-based oil and the like produced from petroleum as a raw material. One kind of extended oil may be used alone, or two or more kinds thereof may be used in combination.

—Content of Styrene-Butadiene Rubber-Containing Component—

The content of the styrene-butadiene rubber-containing component with respect to 100 parts by mass of the polymer component is not particularly limited and may be arbitrarily selected according to the purpose in the case where styrene-butadiene rubber is oil-extended styrene-butadiene rubber.

The use of oil-extended styrene-butadiene rubber as the styrene-butadiene rubber allows sufficient improvement in adhesiveness.

Further, the content of the styrene-butadiene rubber-containing component with respect to 100 parts by mass of the polymer component is not particularly limited and may be arbitrarily selected according to the purpose as long as the styrene-butadiene rubber is not oil-extended styrene-butadiene rubber and the content thereof is less than 50 parts by mass. However, the content thereof is preferably 10 parts by mass or more and less than 50 parts by mass, more preferably 10 parts by mass or more and 40 parts by mass or less, and furthermore preferably 10 parts by mass or more and 30 parts by mass or less.

The content thereof being less than 50 parts by mass may improve adhesiveness sufficiently. The above-mentioned content set within the preferred range or within the more preferred range may further improve adhesiveness.

—Styrene Content in Styrene-Butadiene Rubber-Containing Component—

The styrene content in the styrene-butadiene rubber-containing component is not particularly limited and may be arbitrarily selected according to the purpose as long as it is less than 20 mass %. However, the styrene content is preferably 10 mass % and more and less than 20 mass %, and more preferably 15 mass % or more and less than 20 mass %.

The styrene content of 20 mass % or more fails to improve adhesiveness sufficiently.

The styrene content within the preferred range or within the more preferred range is advantageous in that a rubber part having improved anti-cut resistance can be obtained.

—Butadiene Rubber (BR)—

Butadiene rubber is a polymer of butadiene monomers. The styrene-butadiene rubber-containing component may or may not contain butadiene rubber. However, butadiene rubber may be advantageously contained as it can provide a rubber part further improved in wear resistance.

——Cis-1,4-Bond Content of Butadiene Rubber——

Cis-1,4-bond content in the butadiene rubber is not particularly limited and may be arbitrarily selected according to the purpose. However, the cis-1,4-bond content therein is preferably 90% or more, more preferably 93% or more, and particularly preferably 95% or more.

The cis-1,4-bond content of less than 90% may deteriorate wear resistance. On the other hand, the cis-1,4-bond content within the preferred range is advantageous from a viewpoint of wear resistance. Further, the cis-1,4-bond content within the more preferred range or within the particularly preferred range is more advantageous.

Note that, the cis-1,4-bond content may be measured by using 1H-NMR, 13C-NMR, FT-IR, and the like.

——Content of Butadiene Rubber——

The content of the butadiene rubber is not particularly limited and may be arbitrarily selected according to the purpose, but is preferably 10 to 50 parts by mass with respect to 100 parts by mass of the styrene-butadiene rubber-containing component.

The butadiene rubber content within the preferred range or within the more preferred range with respect to 100 parts by mass of the styrene-butadiene rubber-containing component is advantageous in that a rubber part having improved wear resistance can be obtained.

<<Other Polymers>>

Other polymers to be included in the polymer component as required are not particularly limited as long as they are polymers and may be arbitrarily selected. Examples thereof may include: natural rubber (NR); isoprene rubber (IR); acrylonitrile-butadiene rubber (NBR); chloroprene rubber (CR); butyl rubber (IIR); ethylene-propylene rubber (EPM); chlorosulfonated polyethylene rubber (CSM); and urethane rubber (U). One kind of polymer may be used alone, or two or more kinds thereof may be used in combination.

Among these, natural rubber and/or isoprene rubber is advantageous in that a rubber part having fatigue resistance and breaking characteristics can be obtained.

Natural Rubber (NR)—

The content of the natural rubber is not particularly limited and may be arbitrarily selected according to the purpose, but is preferably 50 parts by mass or more, more preferably 50 parts by mass or more and 90 parts by mass or less, and furthermore preferably 70 parts by mass or more and 90 parts by mass or less. Natural rubber may be advantageously blended within the above-mentioned range in that it can provide a rubber part improved in adhesiveness and further improved in fatigue resistance and breaking characteristics.

<Other Components>

Other components to be included in the rubber composition as required are not particularly limited and may be arbitrarily selected according to the purpose. Examples thereof may include: a vulcanizing agent; a vulcanization accelerator; a vulcanization accelerator aid; a reinforcing agent; a plasticizer; an age resistor; an anti-scorch agent; a softener; and a filler. One kind thereof may be used alone, or two or more kinds thereof may be used in combination.

<<Vulcanizing Agent>>

The vulcanizing agent is not particularly limited and may be arbitrarily selected according to the purpose as long as it is capable of vulcanizing a polymer. Examples thereof may include: organic peroxides such as benzoyl peroxide, dicumyl peroxide, di-t-butyl peroxide, t-butyl cumyl peroxide, methyl ethyl ketone peroxide, cumene hydroperoxide, and 2,5-dimethyl-2,5-di(t-butyl peroxy)hexane; and sulfur-based vulcanizing agents such as sulfur and morpholine disulfide. One kind thereof may be used alone, or two or more kinds thereof may be used in combination.

Among these, sulfur may be advantageously used in that it leads to good storage stability, allowing easy handling and in that vulcanization with sulfur is capable of providing rubber parts having improved fatigue resistance.

<<Vulcanization Accelerator>>

The vulcanization accelerator is not particularly limited and may be arbitrarily selected according to the purpose. Examples thereof may include: a sulfonamide-based vulcanization accelerator such as CBS (N-cyclohexyl-2-benzothiazyl sulfonamide), TBBS (N-t-butyl-2-benzothiazyl sulfoamide), or TBSI (N-t-butyl-2-benzothiazyl sulfonimide); a guanidine-based vulcanization accelerator such as DPG (diphenyl guanidine); a thiuram-based vulcanization accelerator such as tetraoctylthiuram disulfide and tetrabenzylthiuram disulfide; and a vulcanization accelerator such as zinc dialkyldithiophosphate. One kind thereof may be used alone, or two or more kinds thereof may be used in combination.

<<Vulcanization Accelerator Aid>>

The vulcanization accelerator aid is not particularly limited and may be arbitrarily used according to the purpose as long as it is compounded from a viewpoint of accelerating vulcanization. Examples thereof may include zinc oxide (ZnO) and steric acid. One kind thereof may be used alone, or two or more kinds thereof may be used in combination.

<<Reinforcing Agent>>

The reinforcing agent is not particularly limited and may be arbitrarily selected according to the purpose. Examples thereof may include carbon black and silica. One kind thereof may be used alone, or two or more kinds thereof may be used in combination.

—Carbon Black—

Carbon black is not particularly limited as long as it is generally used in the rubber industry. Examples thereof may include carbon black of grades SRF, GPF, FEF, HAF, ISAF, SAF, FT, and MT.

As disclosed herein, carbon black of HAF grade may be suitably used from a viewpoint of maintaining rubber breaking characteristics and improving adhesiveness. Note that, from a viewpoint of wear resistance, high grade carbon may be desirably used, and carbon black of grades FEF, HAF, ISAF, and SAF may be preferably used. In this case, one kind of carbon black may be used alone, or two or more kinds thereof may be used in combination.

Note that, carbon black preferably has a nitrogen adsorption specific surface area of 10 to 150 m²/g and a dibutylphthalate (DBP) absorption of 50 to 200 mL/100 g.

The content of carbon black is not particularly limited and may be arbitrarily selected according to the purpose, but is preferably 30 to 80 parts by mass with respect to 100 parts by mass of the polymer component.

Carbon black may be advantageously blended within the preferred range in that it can improve rubber refining workability and provide a rubber part having improved reinforcing property.

<<Plasticizer>>

The plasticizer is not particularly limited and may be arbitrarily selected according to the purpose. Examples thereof may include: process oil such as aromatic oil, naphthenic oil, or paraffin oil; vegetable oil such as coconut oil; and synthetic oil such as alkylbenzene oil. One kind thereof may be used alone, or two or more kinds thereof may be used in combination.

<<Age Resistor>>

The age resistor is not particularly limited, and a phenol-based age resistor, which is an anti-staining age resistor may be suitably used. Examples thereof may include: a monophenol-based age resistor such as N-(1,3-dimethylbutyl)-N′-phenyl-p-phenylenediamine, 1-oxy-3-methyl-4-isopropylbenzene, 2,6-di-t-butyl-4-ethylphenol, butyl hydroxyanisole, 2,6-di-t-butyl-α-dimethylamino-p-cresol, a mixed product of 2,6-di-t-butylphenol, 2,4,6-tri-t-butylphenol, and o-t-butylphenol, a mixed product of 2,6-di-t-butylphenol, 2,4-di-t-butylphenol, 2,4,6-tri-t-butylphenol, and other substituted phenol, styrenated phenol, alkylated phenol, a mixed product of alkyl- and aralkyl-substituted phenol, or a phenol derivative; a bis, tris, or polyphenol-based age resistor such as 2,2′-methylenebis(4-methyl-6-t-butylphenol), 2,2′-methylenebis(4-methyl-6-cyclohexylphenol), 2,2′-methylenebis(4-ethyl-6-t-butylphenol), 4,4′-methylenebis(2,6-di-t-butylphenol), methylene-crosslinked polyalkylphenol, 2,2′-ethylidenebis(4,6-di-t-butylphenol), alkylated bisphenol, a butylated reaction product of p-cresol and dicylopentadiene, a mixture of polybutylated bisphenol A; a thiobisphenol-based age resistor such as 4,4′-thiobis(6-t-butyl-3-methylphenol), 4,4′-thiobis(6-t-butyl-o-cresol), or 4,4′-di and trithiobis(2,6-di-t-butylphenol); and a hindered phenol-based age resistor such as 4,4′-butylidenebis(3-methyl-6-t-butylphenol), 2,4-bis[(octylthio)methyl)]-o-cresol, a hindered phenol, or a hindered bisphenol. One kind thereof may be used alone, or two or more kinds thereof may be used in combination.

<<Anti-Scorch Agent>>

The anti-scorch agent is not particularly limited and may be arbitrarily selected according to the purpose. Examples thereof may include: an organic acid such as anhydrous phthalic acid, salicylic acid, or benzoic acid; a nitroso compound such as N-nitrosodiphenylamine; and N-cyclohexyl thiophthalimide. One kind thereof may be used alone, or two or more kinds thereof may be used in combination.

<<Softener>>

The softener is not particularly limited and may be arbitrarily selected according to the purpose. Examples thereof may include: a petroleum-based softener such as process oil, lubricant oil, paraffin, liquid paraffin, petroleum asphalt, or Vaseline; a fatty oil-based softener such as castor oil, linseed oil, rapeseed oil, or coconut oil; waxes such as honey wax, carnauba wax, or lanolin; tall oil, linolic acid, palmitic acid, steric acid, and lauric acid. One kind thereof may be used alone, or two or more kinds thereof may be used in combination.

<<Filler>>

The filler is not particularly limited and may be arbitrarily selected according to the purpose. Examples thereof may include silicic acid, silica, silicate, alumina, calcium carbonate, magnesium carbonate, barium sulfate, magnesium sulfate, clay, talc, kaolin, short fiber, conductive oxide, ferrites, mica, and graphite. One kind thereof may be used alone, or two or more kinds thereof may be used in combination.

The disclosed rubber composition contains at least a polymer component, in which: the polymer component contains a styrene-butadiene rubber-containing component which consists of either a styrene-butadiene rubber alone or a mixture of a styrene-butadiene rubber and a butadiene rubber; a styrene content in the styrene-butadiene rubber-containing component is less than 20 mass %; and the styrene-butadiene rubber is oil-extended styrene-butadiene rubber.

The disclosed rubber composition is capable of providing rubber parts having improved adhesiveness.

The disclosed rubber composition is a rubber composition containing at least a polymer component, in which: the polymer component contains less than 50 parts by mass of a styrene-butadiene rubber-containing component, which includes either a styrene-butadiene rubber alone or a mixture of a styrene-butadiene rubber and a butadiene rubber, with respect to 100 parts by mass of the polymer component; and the styrene content in the styrene-butadiene rubber-containing component is less than 20 mass %.

The disclosed rubber composition is capable of providing rubber parts having improved adhesiveness.

In this case, styrene-butadiene rubber may be oil-extended styrene-butadiene rubber.

The use of oil-extended styrene-butadiene rubber as the styrene-butadiene rubber may further improve adhesiveness of the rubber parts.

The disclosed rubber composition preferably further contains carbon black of HAF grade. This configuration is capable of providing rubber parts improved in adhesiveness while maintaining rubber breaking characteristics.

In the disclosed rubber composition, the polymer component preferably further contains natural rubber. This configuration is capable of providing rubber parts having improved adhesiveness and improved fatigue resistance and breaking characteristics.

In this case, the polymer component preferably contains 50 parts by mass or more of natural rubber with respect to 100 parts by mass of the polymer component. This configuration can provide rubber parts having further improved adhesiveness.

In the disclosed rubber composition, the styrene-butadiene rubber-containing component is preferably styrene-butadiene rubber alone. This configuration is capable of providing rubber parts having maintained breaking characteristics and further improved adhesiveness.

(Rubber Composite)

The disclosed rubber composite includes at least a first rubber part and a second rubber part adhered together, the first rubber part employing a first rubber composition, the second rubber part employing a second rubber composition, in which the first rubber composition employs the disclosed rubber composition. The disclosed rubber composite is capable of improving the adhesion force at an adhesion site (adhesion surface where the first rubber part and the second rubber part are directly adhered together) of the rubber parts.

The adhesion site is an adhesion surface where the first rubber part and the second rubber part are directly adhered together.

<First Rubber Part>

The first rubber part can be obtained by vulcanizing the rubber composition through curing, for example. The first rubber part contains at least a component derived from the disclosed rubber composition and further contains other components as required.

<<Curing>>

The curing conditions (curing temperature, curing time) are not particularly limited and may be arbitrarily selected according to the purpose.

The curing temperature is not particularly limited and may be arbitrarily selected according to the purpose, but is preferably 120° C. to 180° C. Curing within the above-mentioned range is advantageous in that thermal aging of the rubber can be prevented and curing is possible without reducing the productivity.

<<Other Components>>

The other components to be included in the first rubber part as required is not particularly limited and may be arbitrarily selected according to the purpose. Examples of the other components may include: a release agent; an adhesiveness improvement agent; waxes; oil; a lubricant; a petroleum-based resin; and an ultraviolet absorbing agent.

<Second Rubber Part>

As with the first rubber part, the second rubber part may be a rubber part employing the disclosed rubber composition, particularly a rubber part employing the same rubber composition as that of the first rubber part or may be a rubber part employing a rubber composition different from that of the first rubber part. A rubber part employing the disclosed rubber composition similar to that of the first rubber part, particularly the same rubber part as the first rubber part, or a rubber part employing a styrene-butadiene-based rubber composition may be advantageously used in that it can reliably improve adhesion force at an adhesion site of the rubber parts.

A polymer contained in the rubber composition used for formation of the second rubber part is not particularly limited and may be arbitrarily selected according to the purpose. Examples thereof may include: natural rubber; styrene-butadiene rubber; butadiene rubber; isoprene rubber; chloroprene rubber; acrylonitrile-butadiene rubber; butyl rubber; ethylene-propylene rubber; ethylene-propylene-diene rubber (EPDM); urethane rubber; silicone rubber; and fluororubber. One kind thereof may be used alone, and two or more kinds thereof may be used in combination.

Among these, a plurality of rubber selected from styrene-butadiene rubber, natural rubber, butadiene rubber, isoprene rubber, butyl rubber, acrylonitrile-butadiene rubber, and chloroprene rubber may be advantageously used in that it can improve adhesion force of the rubber composite to be obtained. The first rubber part is a rubber part employing the disclosed rubber composition, and thus sufficient adhesiveness can be obtained with respect to the second rubber part employing a rubber composition mainly including SBR (containing 50 parts or more, particularly 100 parts).

<Adhesion Condition>

Adhesion conditions (adhesion temperature, adhesion time) of the rubber parts are not particularly limited and may be arbitrarily selected according to the purpose.

The adhesion temperature is not particularly limited and may be arbitrarily selected according to the purpose, but is preferably 120° C. to 180° C. The rubber parts may be advantageously adhered within the above-mentioned range in that the rubber parts can be adhered while avoiding thermal aging and without reducing the productivity.

The disclosed rubber composite includes the first rubber part and the second rubber part adhered together, the first rubber part employing the first rubber composition, the second rubber part employing the second rubber composition, in which the first rubber composition is the disclosed rubber composition. The disclosed rubber composite is capable of improving the adhesion force at the adhesion site of the rubber parts.

In the disclosed rubber composite, the second rubber composition is preferably a styrene-butadiene-based rubber composition. The disclosed rubber composition has favorable adhesiveness with the styrene-butadiene-based rubber composition, and thus adhesion force at the adhesion site of the rubber parts may be reliably improved.

In the disclosed rubber composite, the second rubber composition is preferably the disclosed rubber composition. This configuration is capable of reliably improving the adhesion force at an adhesion site of the rubber parts.

(Rubber Crawler)

The disclosed rubber crawler includes at least the disclosed rubber composite. Further, the disclosed rubber crawler has an adhesion site between rubber parts within the rubber crawler. The disclosed rubber crawler is capable of improving the adhesion force at the adhesion site between the rubber parts and also anti-peeling property of the adhesion site.

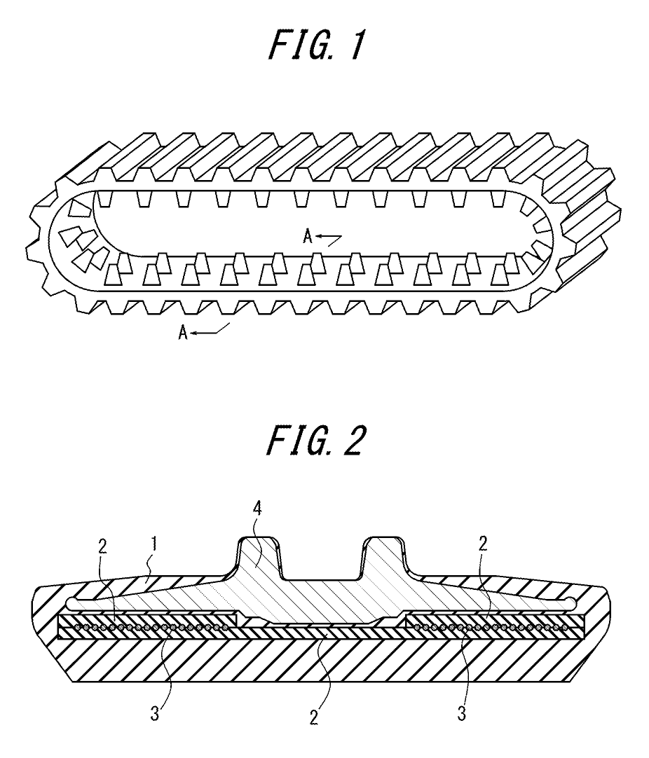

FIG. 1 is a schematic perspective view illustrating an example of the disclosed rubber crawler.

FIG. 2 is a schematic sectional view taken along the line A-A of FIG. 1.

In FIG. 2, the rubber crawler includes: a core 4; a zinc-plated steel cord (or a brass-plated steel cord) 3; an intermediate rubber layer 2 coating the zinc-plated steel cord (or a brass-plated steel cord) 3; and a tread rubber layer 1 coating the intermediate rubber layer 2. For example, the rubber crawler has an adhered surface (adhesion site) where rubber parts are directly adhered together between the intermediate rubber layer 2 and the tread rubber layer 1, and the tread rubber layer 1 and the intermediate rubber layer 2 make up the rubber composite.

The disclosed rubber crawler includes the disclosed rubber composite. The disclosed rubber crawler is capable of improving the adhesion force at the adhesion site of the rubber parts.

### EXAMPLES

### Examples

Hereinafter, the present disclosure will be described more specifically by way of Examples. However, the present disclosure is not limited by the following Examples in any way, and various modifications are possible within the scope of the claims.

### Examples 1 to 8, Comparative Examples 1 to 4

Rubber compositions having formulations presented in Tables 1 and 2 were kneaded following a conventional method and rolled into sheets each having a thickness of 3 mm. Two of the obtained sheets were adhered together, and a backing canvas was adhered to both outer surfaces. Then, using a mold of 180 mm in length×270 mm in width×6 mm in thickness, the resultant was vulcanized and cured under the conditions of 150° C., 30 minutes, and a surface pressure of 10 kg/cm². The resulting sheet was cut into 4 pieces of 180 mm in length×25 mm in width, to thereby obtain adhered samples.

Further, rubber compositions having formulations presented in Tables 1 and 2 were kneaded following a conventional method, and the resultant was vulcanized and cured under the conditions of 155° C., 30 minutes, and a surface pressure of 30 kg/cm², to thereby obtain vulcanized rubber. The vulcanized rubber was punched out using the JIS No. 3 dumbbell, to thereby obtain breaking resistance samples.

Adhesion force on an adhesion surface between the rubber parts was evaluated by peel force (N/mm) and rubber adhesion (%). Breaking resistance was evaluated by breaking strength (MPa). The results are illustrated in Tables 1 and 2. In Tables 1 and 2, the columns under “same rubber” represent evaluation results of the adhesive samples obtained from rubber parts employing the same rubber composition, and the columns under “with respect to rubber containing 100 parts of SBR” represent evaluation results of the adhesive samples each obtained with a rubber part employing a rubber composition containing: 100 parts by mass of SBR (23.5%) (JSR 1500: styrene content (mass % of structural part represented by the above-mentioned formula (I) in styrene-butadiene rubber is 23.5% (available from JSR Corporation)); 60 parts by mass of carbon black (HAF); 1 part by mass of steric acid; 1.5 parts by mass of an age resistor 6C; 4 parts by mass of zinc oxide; 1 part by mass of a vulcanization accelerator DPG (NOCCELER D: N,N′-Diphenylguianidine (available from Ouchi Shinko Chemical Industrial Co., Ltd.)); and 1.7 parts by mass of sulfur.

<Peel Force Evaluation>

A cut was made on an adhesion site of the adhered sample with a knife, and a 180° peel strength of an adhered surface of the rubber part (at tensile strength of 50 mm/min) was measured in accordance with JIS K6854. Larger values of peel force [N/mm] indicate stronger adhesion forces.

<Rubber Adhesion>

A cut was made on the adhered part of the adhered sample with a knife for tensile peel at 180°. The adhered surface of the peeled adhered sample was visually observed, and a ratio of parts with noticeable irregularities with respect to the surface area of the adhered surface was evaluated as rubber adhesion (%). For example, through visual observation of the adhered surface, if the parts with noticeable irregularities account for 70% and smooth area accounts for 30%, rubber adhesion (%) was evaluated as 70%. Larger values of rubber adhesion (%) indicate stronger adhesion forces.

<Breaking Resistance>

The breaking sample was subjected to tensile test at 25° C. in accordance with JIS K6251, to thereby measure the breaking strength.

TABLE 1

| | | | Example 1 | Example 2 | Example 3 | Example 4 | Example 5 | Example 6 |
|---|---|---|---|---|---|---|---|---|
| Polymer | Natural rubber (NR RSS#3) | — | 80 | 80 | 80 | 80 | 60 | 40 |
| component | Oil-extended styrene-butadiene | *1 | — | — | 10 | — | — | — |
| | rubber (SBR(25%)) | | | | | | | |
| | Styrene-butadiene rubber | *2 | — | — | — | 10 | — | — |
| | (SBR(25%)) | | | | | | | |
| | Oil-extended styrene-butadiene | *3 | 20 | — | — | — | 40 | 60 |
| | rubber (SBR(18%)) | | | | | | | |
| | Styrene-butadiene rubber | *4 | — | 20 | — | — | — | — |
| | (SBR(18%)) | | | | | | | |
| | Styrene-butadiene rubber | *5 | — | — | — | — | — | — |
| | (SBR(65%)) | | | | | | | |
| | Butadiene rubber (BR) | *6 | — | — | 10 | 10 | — | — |
| Reinforcing | Carbon black HAF | — | 60 | 60 | 60 | 60 | 60 | 60 |
| agent | Carbon black ISAF | — | — | — | — | — | — | — |
| | Carbon black FEF | — | — | — | — | — | — | — |
| Compounding | Stearic acid | — | 2 | 2 | 2 | 2 | 2 | 2 |
| agent | Age resistor 6C | *7 | 1 | 1 | 1 | 1 | 1 | 1 |
| | Zinc oxide | — | 3 | 3 | 3 | 3 | 3 | 3 |
| | Process oil | — | 12 | 12 | 12 | 12 | 12 | 12 |
| | Vulcanization accelerator NS | *8 | 0.6 | 0.6 | 0.6 | 0.6 | 0.6 | 0.6 |
| | Sulfur | — | 2.3 | 2.3 | 2.3 | 2.3 | 2.3 | 2.3 |
| Styrene content | | % | 18 | 18 | 12.5 | 12.5 | 18 | 18 |
| Adhesion | Against the same rubber | Peel force | 55 | 55 | 52 | 51 | 54 | 51 |
| | | [N/mm] | | | | | | |
| | | Rubber adhesion | 100 | 100 | 100 | 100 | 100 | 88 |
| | | [%] | | | | | | |
| | With respect to 100 parts of | Peel force | 54 | 54 | 54 | 54 | 57 | 49 |
| | SBR | [N/mm] | | | | | | |
| | | Rubber adhesion | 100 | 81 | 100 | 88 | 94 | 88 |
| | | [%] | | | | | | |

| | | | | | | | |
|---|---|---|---|---|---|---|---|
| Breaking resistance | Breaking strength | 24.2 | 23.0 | 22.9 | 22.5 | 24.2 | 23.5 |
| | [Mpa] | | | | | | |

TABLE 2

| | | | | | Comparative | Comparative | Comparative | Comparative |
|---|---|---|---|---|---|---|---|---|
| | | | Example 7 | Example 8 | Example 1 | Example 2 | Example 3 | Example 4 |
| Polymer | Natural rubber (NR RSS#3) | — | 80 | 60 | 80 | 40 | 80 | 80 |
| component | Oil-extended styrene-butadiene | *1 | 10 | — | 20 | — | — | — |
| | rubber (SBR(25%)) | | | | | | | |
| | Styrene-butadiene rubber | *2 | — | — | — | — | — | — |
| | (SBR(25%)) | | | | | | | |
| | Oil-extended styrene-butadiene | *3 | — | — | — | — | — | — |
| | rubber (SBR(18%)) | | | | | | | |
| | Styrene-butadiene rubber | *4 | — | 40 | — | 60 | — | — |
| | (SBR(18%)) | | | | | | | |
| | Styrene-butadiene rubber | *5 | — | — | — | — | — | 20 |
| | (SBR(65%)) | | | | | | | |
| | Butadiene rubber (BR) | *6 | 10 | — | — | — | 20 | — |
| Reinforcing | Carbon black HAF | — | — | 60 | 60 | 60 | 60 | 60 |
| agent | Carbon black ISAF | — | 50 | — | — | — | — | — |
| | Carbon black FEF | — | 10 | — | — | — | — | — |
| Compounding | Stearic acid | — | 2 | 2 | 2 | 2 | 2 | 2 |
| agent | Age resistor 6C | *7 | 1 | 1 | 1 | 1 | 1 | 1 |
| | Zinc oxide | — | 3 | 3 | 3 | 3 | 3 | 3 |
| | Process oil | — | 12 | 12 | 12 | 12 | 12 | 12 |
| | Vulcanization accelerator NS | *8 | 0.6 | 0.6 | 0.6 | 0.6 | 0.6 | 0.6 |
| | Sulfur | — | 2.3 | 2.3 | 2.3 | 2.3 | 2.3 | 2.3 |
| Styrene content | | % | 12.5 | 18 | 25 | 18 | 0 | 65 |
| Adhesion | Against the same rubber | Peel force | 57 | 53 | 55 | 49 | 54 | 50 |
| | | [N/mm] | | | | | | |
| | | Rubber adhesion | 100 | 100 | 100 | 75 | 100 | 100 |
| | | [%] | | | | | | |
| | With respect to 100 parts of | Peel force | 50 | 57 | 51 | 44 | 61 | 31 |
| | SBR | [N/mm] | | | | | | |
| | | Rubber adhesion | 88 | 88 | 75 | 69 | 100 | 25 |
| | | [%] | | | | | | |

| | | | | | | | |
|---|---|---|---|---|---|---|---|
| Breaking resistance | Breaking strength | 24.2 | 23.8 | 24.9 | 23 | 21.5 | 21.6 |
| | [Mpa] | | | | | | |

Notes)
*1: Oil-extended styrene-butadiene rubber (SBR (25%)): Tufdene 2830: styrene content (mass % of structural part represented by the formula (II) in oil-extended styrene-butadiene rubber) of 25 mass % (available from Asahi Kasei Chemicals Corporation)
*2: Styrene-butadiene rubber (SBR (25%)): Tufdene 2000R: styrene content of 25 mass % (available from Asahi Kasei Chemicals Corporation)
*3: Oil-extended styrene-butadiene rubber (SBR (18%)): Tufdene 1834: styrene content of 18 mass % (available from Asahi Kasei Chemicals Corporation)
*4: Styrene-butadiene rubber (SBR (18%)): Tufdene 1000: styrene content of 18 mass % (available from Asahi Kasei Chemicals Corporation)
*5: Styrene-butadiene rubber (SBR (65%)): Asaprene 6500P: styrene content of 65 mass % (available from Asahi Kasei Chemicals Corporation)
*6: Butadiene rubber (BR): JSR BR01 (available from JSR Corporation)
*7: Age resistor 6C: NOCRAC 6C: N-(1,3-dimethylbutyl)-N′-phenyl-p-phenylenediamine (available from Ouchi Shinko Chemical Industrial Co., Ltd.)
*8: Vulcanization accelerator NS: SANCELER NS-G: N-(t-butyl)-2-benzothiazyl sulfonamide (available from Sanshin Chemical Industry Co., Ltd.)

Note that the values of “process oil” in the tables include extended oil in oil-extended styrene-butadiene rubber in the case where styrene-butadiene rubber is oil-extended styrene-butadiene rubber.

Each of the values of “oil-extended styrene-butadiene rubber” in the tables includes no extended oil in oil-extended styrene-butadiene rubber.

Table 1 indicates that Example having a styrene content of less than 20.00 mass % in the styrene-butadiene rubber-containing component and containing oil-extended styrene-butadiene rubber as styrene-butadiene rubber and Examples (Examples 1 to 8) containing less than 50 parts by mass of the styrene-butadiene rubber-containing component with respect to 100 parts by mass of the polymer component have better rubber adhesion between the same kind of rubber and rubber adhesion with rubber containing 100 parts of SBR than Comparative Example 2 containing no oil-extended styrene-butadiene rubber as styrene-butadiene rubber and 50 parts by mass or more of the styrene-butadiene rubber-containing component with respect to 100 parts by mass of the polymer component. Examples 1 to 8 having good rubber adhesion (%) can be evaluated to have high adhesion force between the rubber parts. Thus, it is clear that Examples 1 to 8 have better adhesiveness than that of Comparative Examples 1, 2, and 4. Note that Comparative Example 3 has adhesiveness similar to that of Examples 1 to 8 but has poor breaking characteristics.

Table 1 indicates that rubber adhesion is excellent with the disclosed configuration in which: the styrene-butadiene-containing polymer component contains styrene-butadiene rubber alone or further contains butadiene rubber; styrene-butadiene rubber is oil-extended styrene-butadiene rubber; or the butadiene rubber-containing component is less than 50 parts by mass with respect to 100 parts by mass of the polymer component.

### INDUSTRIAL APPLICABILITY

The disclosed rubber composition may be preferably used as rubber for a rubber crawler, in particular. The rubber crawler may be preferably used for agricultural machinery, building machinery, and construction machinery.

### REFERENCE SIGNS LIST

1 tread rubber layer
2 intermediate rubber layer
3 zinc-plated steel cord (or brass-plated steel cord)
4 core

1. (canceled)

2. A rubber composition containing at least a polymer component, wherein:
the polymer component contains less than 50 parts by mass of a styrene-butadiene rubber-containing component with respect to 100 parts by mass of the polymer component, the styrene-butadiene rubber-containing component comprising either a styrene-butadiene rubber alone or a mixture of a styrene-butadiene rubber and a butadiene rubber;
a styrene content in the styrene-butadiene rubber-containing component is less than 20 mass %;
the styrene butadiene rubber comprises an oil extended styrene butadiene rubber,
the rubber composition further comprises carbon black of HAF grade and
the content of the styrene-butadiene rubber containing component with respect to 100 parts by mass of the polymer component is 10 parts by mass or more and 30 parts by mass or less.

3. (canceled)

4. (canceled)

5. The rubber composition according to claim 2, wherein the polymer component further comprises natural rubber.

6. The rubber composition according to claim 5, wherein the polymer component contains 50 parts by mass or more of natural rubber with respect to 100 parts by mass of the polymer component.

7. The rubber composition according to claim 2, wherein the styrene-butadiene rubber-containing component comprises a styrene-butadiene rubber alone.

8. A rubber composite comprising a first rubber part and a second rubber part adhered together, the first rubber part employing a first rubber composition, the second rubber part employing a second rubber composition, wherein
the first rubber composition comprises the rubber composition according to claim 2.

9. The rubber composite according to claim 8, wherein the second rubber composition comprises a styrene-butadiene rubber-based composition.

10. A rubber composite comprising a first rubber part and a second rubber part adhered together, the first rubber part employing a first rubber composition, the second rubber part employing a second rubber composition wherein
the first rubber composition and the second rubber composition comprise the rubber composition according to claim 2 respectively.

11. A rubber crawler, comprising the rubber composite according to claim 8.

12. The rubber composition according to claim 5, wherein the styrene-butadiene rubber-containing component comprises a styrene-butadiene rubber alone.

13. A rubber composite comprising a first rubber part and a second rubber part adhered together, the first rubber part employing a first rubber composition, the second rubber part employing a second rubber composition, wherein
the first rubber composition comprises the rubber composition according to claim 5.

14. The rubber composite according to claim 13, wherein the second rubber composition comprises a styrene-butadiene rubber-based composition.

15. A rubber composite comprising a first rubber part and a second rubber part adhered together, the first rubber part employing a first rubber composition, the second rubber part employing a second rubber composition, wherein
the first rubber composition and the second rubber composition comprise the rubber composition according to claim 5 respectively.

16. A rubber crawler, comprising the rubber composite according to claim 13.

17. The rubber composition according to claim 6, wherein the styrene-butadiene rubber-containing component comprises a styrene-butadiene rubber alone.

18. A rubber composite comprising a first rubber part and a second rubber part adhered together, the first rubber part employing a first rubber composition, the second rubber part employing a second rubber composition, wherein
the first rubber composition comprises the rubber composition according to claim 6.

19. The rubber composite according to claim 18, wherein the second rubber composition comprises a styrene-butadiene rubber-based composition.

20. A rubber composite comprising a first rubber part and a second rubber part adhered together, the first rubber part employing a first rubber composition, the second rubber part employing a second rubber composition, wherein
the first rubber composition and the second rubber composition comprise the rubber composition according to claim 6 respectively.

21. A rubber crawler, comprising the rubber composite according to claim 18.

22. A rubber composite comprising a first rubber part and a second rubber part adhered together, the first rubber part employing a first rubber composition, the second rubber part employing a second rubber composition, wherein
the first rubber composition comprises the rubber composition according to claim 7.

23. The rubber composite according to claim 22, wherein the second rubber composition comprises a styrene-butadiene rubber-based composition.
